(19) United States
(12) Patent Application Publication
(10) Pub. No.: US 2013/0164706 A1
(43) Pub. Date: Jun. 27, 2013

(54) ADJUSTABLE SUCTION TIPS FOR DENTAL AND MEDICAL USES

(71) Applicants: Nishan ODABASHIAN, Glendale, CA (US); Saro KHOJASARIAN, Glendale, CA (US); Hovik KARAPETIAN, Montrose, CA (US)

(72) Inventors: Nishan ODABASHIAN, Glendale, CA (US); Saro KHOJASARIAN, Glendale, CA (US); Hovik KARAPETIAN, Montrose, CA (US)

(73) Assignee: GSN PRODUCTS, INC., Glendale, CA (US)

(21) Appl. No.: 13/336,403

(22) Filed: Dec. 23, 2011

(51) Int. Cl. A61C 17/08

(52) U.S. Cl. 433/92; 433/96

(57) ABSTRACT

An implement useful in dental and medical procedures, particularly aspiration, but that can also be readily adapted for irrigation or retraction, is described. In a preferred embodiment, the invention features a hollow handle portion 2 having a source end 2a for connecting to a vacuum line or pump, and a second end 2b; a hollow nozzle portion 1 having a contacting end 1a for engaging a patient surface to be suctioned and a second end 1b for functionally engaging, directly or indirectly, the second end of the handle 2b; and a hollow joint at least partially defined by the second end of the handle and the second end of the nozzle. In some embodiments, the joint may comprise an adaptor 3.

### RELATED APPLICATIONS

None.

### GOVERNMENT RIGHTS

None.

### FIELD OF USE

The invention relates to aspirating devices in the medical, dental and veterinary arts, but with potential application to other fields as well.

### BACKGROUND OF THE INVENTION

Dentistry, oral surgery and medical procedures in general typically require aspiration of liquid and debris, and/or retraction of soft tissues. This has been historically accomplished using straight or fixed-angled suction tips. The fixed nature of these contributes to an overall inefficient and uncomfortable process. For example, surfaces to be suctioned/retracted are often of numerous different presentations and angles, and often in cramped, confined spaces. Using a straight or fixed-tip implement leads to tedious, inefficient and incomplete contacting, with consequent inefficient suctioning and retraction. This in turn protracts and complicates procedures, often working discomfort on both patient and operator alike. It is estimated that this occurs millions of times each day around the world, and has been a problem ever since the advent of modern medicine and dentistry.

The following documents illustrate the problem: U.S. Pat. No. 5,061,180 to Gary B. Wiele, filed for on May 1, 1989, and issued on Oct. 29, 1991 (describing a combined vacuum/irrigation implement made out of fitted concentric tube pieces that afford internal rotation and longitudinal sliding of conduits within but limited or no lateral adjustability); U.S. Pat. No. 4,883,426 to Euler Ferrer, filed for on Jul. 5, 1988 and issued on Nov. 28, 1999 (disclosing a fixed arcuate-shaped tissue-retraction and suction tip featuring a lateral orifice that permits modulated suction); U.S. Pat. No. 4,878,900 to T. M Sunt, issued in November, 1989 (teaches similarly); U.S. Pat. No. 3,090,122 to N. R. Erickson, filed for on Jan. 18, 1961 and issued on May 21, 1963 (teaching similarly).

Various attempts have been described to overcome these drawbacks but have so far not met with success, i.e., they have proven overly complicated, expensive, impractical and/or unworkable. Some are typified by joint-less, flexible hose portions made from plastic incorporating malleable wiring and/or wire ribbing See, e.g., U.S. Pat. No. 4,487,600 to A. W. Brownlie et al., filed for on May 1, 1989, and issued on Oct. 29, 1991; U.S. Pat. No. 3,256,885 to J. L. Higgens et al., filed for on Jun. 26, 1963 and issued on Jun. 21, 1966. Another attempt, illustrated in U.S. Pat. No. 5,743,736 to M. Folko et al., filed for on Nov. 3, 1994 and issued on Apr. 28, 1998, features a cumbersome multi-jointed assembly and bulbous suction screen head, wherein the different ball and socket joints are unidirectionally positioned.

There remains the need for a simple, inexpensive, adjustable implement of greater versatility that would ameliorate one or more of the above long-felt, unsolved art needs.

### SUMMARY OF THE INVENTION

It is an object of the invention to address one or more of the above long-felt, unsolved needs by providing an adjustable, joint-based implement. The implement is useful in that it is relatively simple in design, easy and versatile in use, cheap to construct, and lends well to disposability and hygiene.

In a first aspect the invention features an adjustable suctioning implement, preferably for dental or medical applications. The implement includes a hollow handle portion having a source end for connecting to a vacuum line or pump and a second end. The implement also features a hollow nozzle portion having a contacting end for engaging a patient surface to be suctioned and a second end for functionally engaging, directly or indirectly, the second end of the handle portion. The implement further includes a hollow joint that is at least partially defined by the second end of the handle and the second end of the nozzle. The implement can be fashioned out of two or more distinct pieces but preferably contains no more than three (including an adaptor), the latter of which is preferably configured in a dual opposing ball or socket configuration.

Although in preferred embodiments the joint features one or two balls and sockets, in another so-called “rotary” embodiment the joint can feature a hollow pivoting drum, e.g., as illustrated in the FIG. 3, one end of which preferably is contiguous with or integral to the handle and the other end of which preferably is contiguous with or integral to the nozzel. The drum (and for that matter, the handle, nozzle, and joint) can be any dimension, e.g., cylindrical, barrel-shaped, rectangular, square, triangular, elliptical, etc. as long as the portion thereof that interfaces cooperatively with the handle allows rotation about an axis perpendicular or substantially perpendicular thereto.

Additional aspects of the invention feature kits and methods of using the implements of the first aspect.

Various embodiments are discussed in the detailed description and accompanying drawings and claims, and yet additional embodiments will be immediately apparent to the person of ordinary skill in the art. For example, it will be appreciated that the invention may also find merit in other uses, e.g., automotive, marine, and manufacturing or servicing. It will also be appreciated that the invention could be alternatively or additionally configured to support irrigation and delivery techniques.

Any combination of individual embodiment features that are discussed can also be combined as suitable.

### BRIEF DESCRIPTION OF THE DRAWINGS

FIGS. 1A-C show an embodiment featuring a single ball and socket joint as between handle and nozzle, with FIG. 1A representing a side perspective view of the assembled implement, FIG. 1B representing an exploded view of the same, and FIG. 1C being a sectional view of the same showing potential for movement/adjustability about the joint.

FIGS. 2A-D show an embodiment featuring a dual ball and socket joint as between handle and nozzle mediated by an intervening modular connector, with FIG. 2A representing a side perspective view of the assembled implement, FIG. 2B representing an exploded view of the same, and FIGS. 2C and 2D representing sectional views of the same.

FIGS. 3A-D show a rotary drum embodiment, with FIG. 3A representing a top orthogonal view, FIG. 3B representing a side perspective view, FIG. 3C being an exploded perspective view, and FIG. 3D representing a partial exploded sectional view of the joint from another angle.

FIGS. 4A-D show another rotary drum embodiment, with FIG. 4A representing a top orthogonal view, FIG. 4B representing a side perspective view, FIG. 4C being an exploded perspective view, and FIG. 4D representing a partial exploded sectional view of the joint from another angle

### DETAILED DESCRIPTION OF PREFERRED EMBODIMENTS

The implements of the invention, depending on aspect and embodiment, contemplate suction, irrigation and/or retraction using all types of fluids and dimensionally cooperative substances and tissues.

In medical and dental aspects and embodiments, body fluids include, e.g., blood and saliva. Irrigation fluids include, e.g., saline, distilled water, sodium hypochlorite, and chlorohexidine.

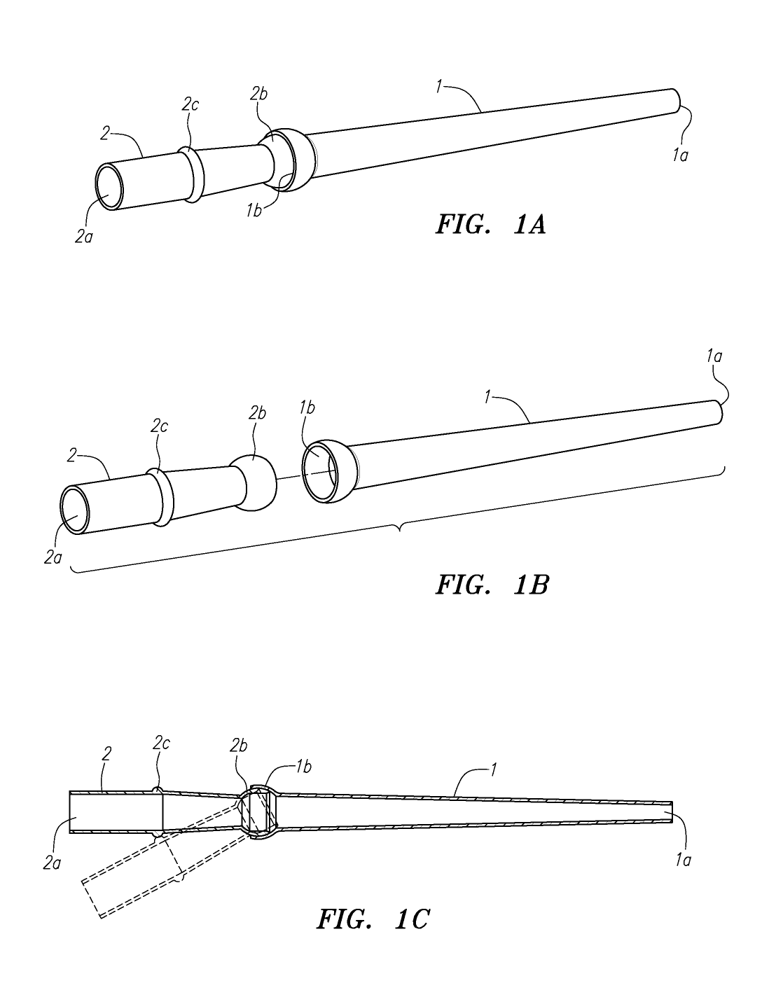

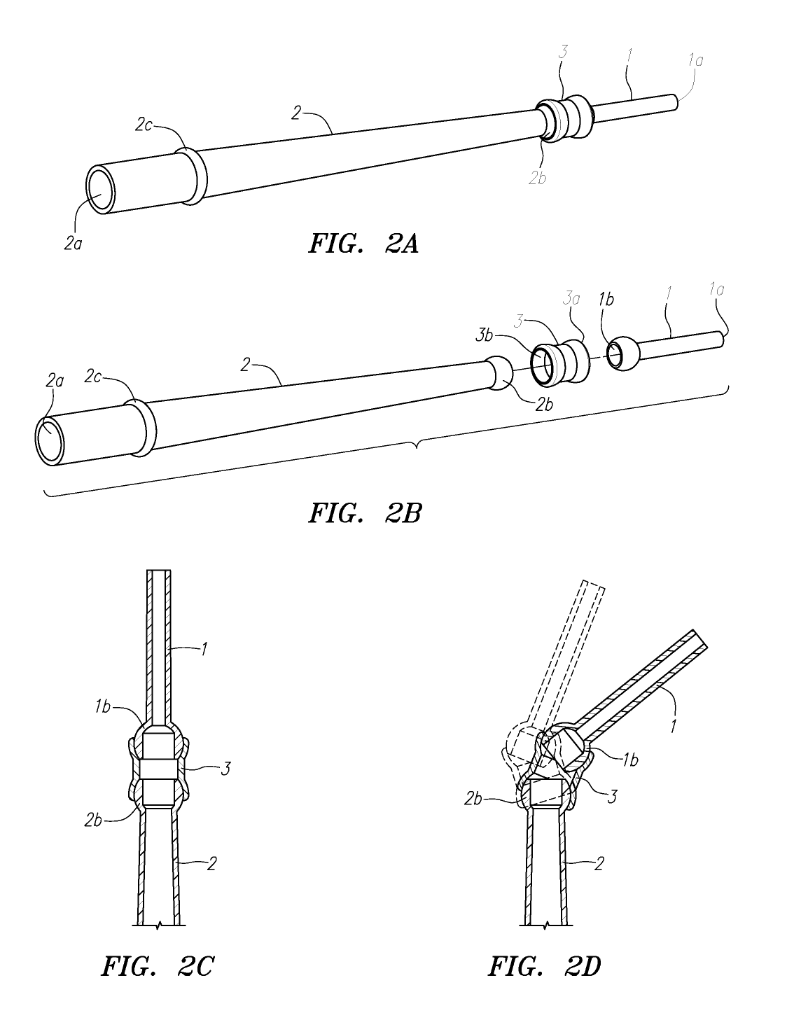

In most embodiments, the implement is assembled from multiple different pieces that functionally fit together at a joint. One preferred embodiment for this is a ball and socket design, in which a first piece bearing a ball-shaped end snaps snugly into the socket-like end of a second piece to allow articulation of the nozzle about the handle via the ball and socket joint between. Although the socket need not be perfectly conforming to the shape of the ball, it should be sufficiently tight that the vacuum/aspirating force within is substantially preserved during use yet the joint can still be manipulated upon sufficient application of force to adjust the angle of approach and/or contact. The advantage is that the joint is potentially movable in a variety of directions, thus endowing good adjustability. Configurations of the ball and socket can be as shown in the drawings or assume the reverse configuration, e.g., where the ball takes the place of the socket and vice-versa relative to the direction of air or fluid flow. FIG. 1 and FIG. 2 feature just two of many different possible ball and socket configurations that can be used, with the dual configuration shown in FIG. 2 being preferred because of its greater range of motion.

As used herein, the term “joint” includes a single or dual ball and socket configuration, as opposed to the plural term “joints,” which includes more than one such joint or multiple different types of joints. Also as used herein and throughout, and unless otherwise specified, the terms “medical,” “dental”, and “surgical” each embrace veterinary as well as human applications.

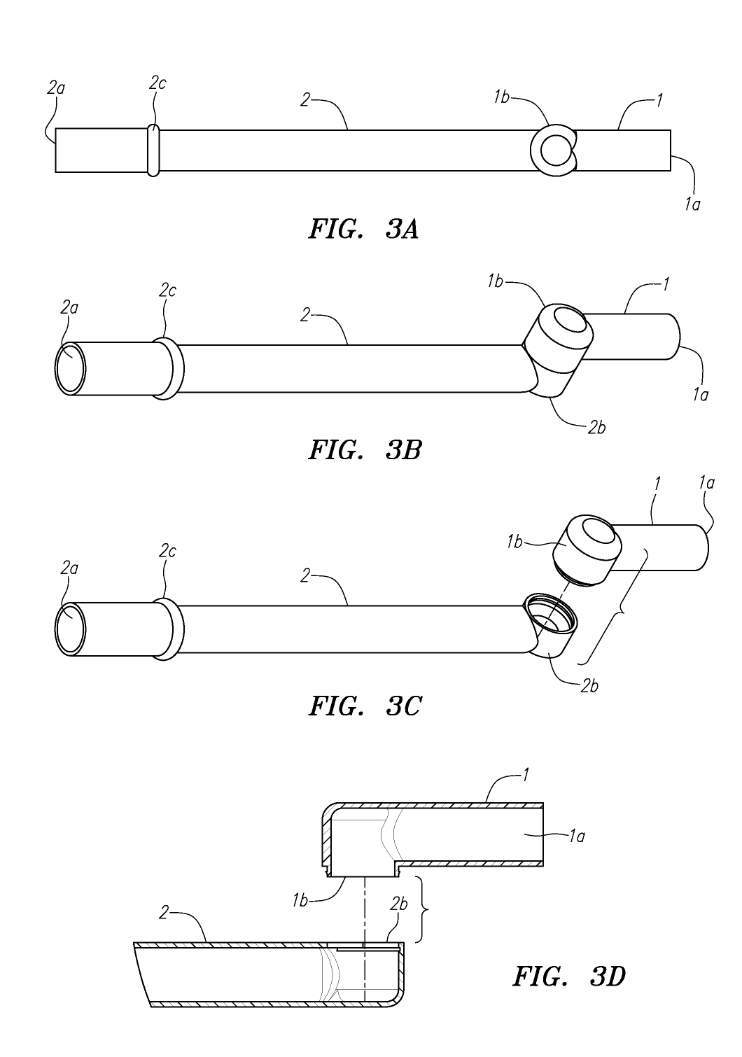

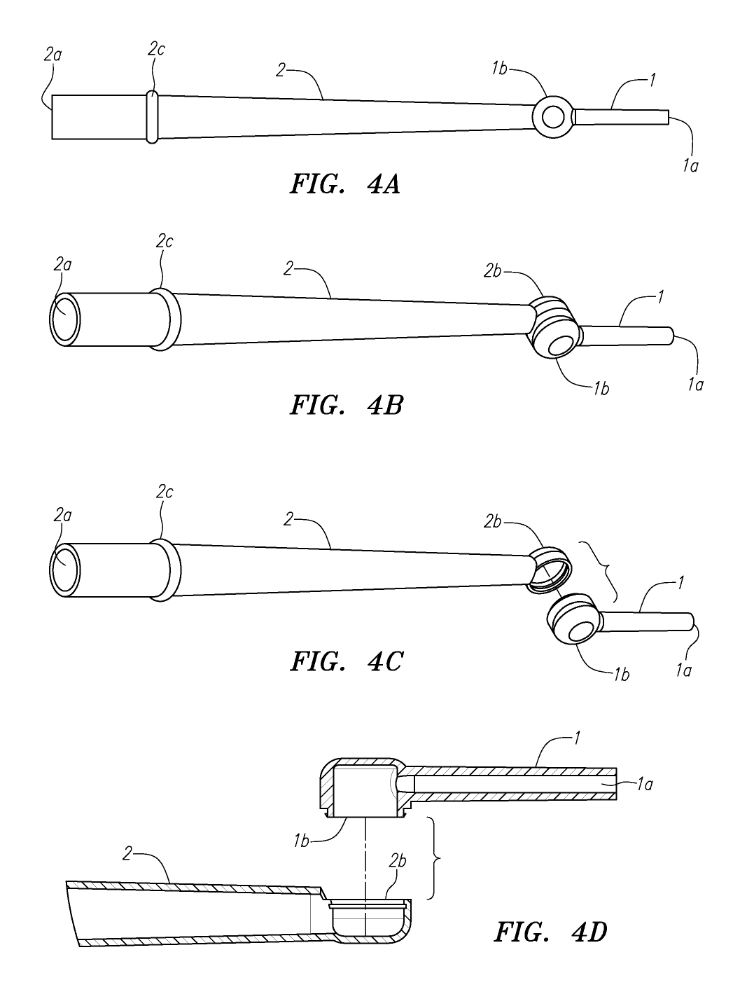

Another joint contemplated by the invention features a rotary joint, two preferred embodiments of which are depicted in FIGS. 3 and 4. This particular joint can assume a rotating drum configuration, or else be ball-and-socket configured as above, with the principal difference being that the ball and socket joint here is configured relatively perpendicular to the longitudinal axes of the handle and nozzle portions in FIGS. 1 and 2.

Implements of the invention can be made from one or more materials selected from the group consisting of metal, molded plastic, rubber, glass and paper, according to well-known methods. For many embodiments, plastic is preferred. Illustrative plastics that can be used include, e.g., polyvinyl chloride (PVC), polystyrene, polypropylene, polycarbonate, and acetate copolymers and these can be formed, e.g., by injection- or blow-molding techniques.

One or more of the handle, nozzle, and joint portions can be fashioned of different materials relative to the other portions. Any given portion can also be manufactured out of combinations of different materials as compatible/appropriate.

In some preferred embodiments where the handle is relatively straight, the joint allows rotational and/or angular pivoting about a central longitudinal axis defined by the handle. In other embodiments, the rotational and/or angular pivoting is offset relative to the aforementioned handle axis in a manner parallel or substantially parallel thereto, e.g., as a consequence of the mating configuration between handle and nozzle.

Each implement is hollow, with an external housing that defines at least one luminal space therein and there through, from one terminal end to the other. It is anticipated that one or more internal flexible tubes can also be fitted within the housing to accomplish the same and/or additional functions.

Joints can be fashioned using an independent connector module or else be formed entirely out of complementary integral ends of the nozzle and handle/body pieces.

In some preferred embodiments, the nozzle end is tapered or narrowly graded toward the suctioning end, which tapering or grading may or may not occur on the handle portion as well.

In some preferred embodiments, the suctioning end of the nozzle is also beveled and may also contain a screen spanning the interfacing orifice to filter out solids. However, most preferred embodiments feature a screen-less nozzle head.

In some preferred embodiments, colorants may be included for color-coding purposes. In other, not necessarily exclusive, embodiments the implement or one or more conduit portions thereof may be transparent or translucent.

In still further embodiments, fiber-optics or other lighting materials and materials for transmitting light can be incorporated into or alongside the plastic, as can malleable metallic wires or ribbing.

Some embodiments may also employ corrugation within the nozzle and/or handle portion to afford additional flexibility.

In some embodiments the implements are each sterilized and/or individually wrapped to promote hygiene. In other embodiments, the implements are reusable, e.g., via steam-autoclaving, infra-red irradiation or immersion in an antiseptic solution.

The implements of the invention, including their individual handle, nozzle and joint portions, can also be of different lengths, widths, diameters, wall thicknesses, tapering dimensions, colors and transparency/transluminescence as appropriate for the particular type of procedure in which they are to be used. The term “handle” does not foreclose the use of a hand or finger on the mesial, facing or nozzle portion of the implement during use.

Preferred dimension ranges include 0.1-3.0 inches for nozzle length; nozzle width: 0.1-0.5 inches; handle length: 1.0-6.0 inches; handle width: 0.1-1.0 inches; and wall thickness: 0.01-0.10 inches.

The implements of the invention may also feature a flanged exterior ring on the handle portion that services as a sealing means between vacuum/pump-line and handle. The line essentially slips over a portion of the handle and seals against the ring. This ring is typically located 0.5-1.0 inches from the source end of the handle.

The implements may also feature one or more laterally positioned apertures, vents, or ports located along the side housing of the nozzle or handle and that are in communication with the internal lumen/vacuum space of the implement. These can be more or less covered by the operator's finger(s) or by slide-able or depressible flaps actuated by such during use, thereby providing for modulation of the amount of suction or positive force exerted at the contact point during a procedure, be it suctioning, blowing or irrigation.

Another way to modulate pressure or increase accessibility is to create a modified vacuuming surface at the point of engagement, e.g., by supply of a nozzle facing that is not perpendicular to the length of the nozzle but cut or molded at an angle thereto.

In some embodiments the contacting end can also be closed as opposed to open and suction/evacuation/irrigation is accomplished using one or more lateral holes, ports or apertures, typically smaller in dimension and distinct from the aforementioned lateral aperture(s).

It is expected that the implements of the invention may also benefit from robotics-mediated procedures, e.g., where the robotics are functionally integrated/interfaced, such as is finding increased use in delicate medical and experimental procedures.

Kits can include multiple individually wrapped implements or else a single external wrapping about nested unwrapped singular implements. Any given kit can also feature two or more implements of different size, dimension, or color, with those of the same size, dimension and/or color segregated together, e.g., in a different pouch or packaging relative to other dimensioned, sized or colored implements.

The following examples are further illustrative of different aspects and embodiments of the invention.

### EXAMPLE 1

### A Single Ball and Socket Joint Embodiment

FIG. 1, including its subparts, shows a two-piece suction implement consisting of a nozzle portion 1 and a handle/body portion 2. Nozzle portion 1 features a hollow interior luminal space terminating in two open ends: a patient contacting end 1a and second end 1b that in this embodiment is cup- or socket-shaped. Handle portion 2 also contains two ends, a source end 2a for connecting to a vacuum line or pump (not shown) and a second end 2b configured in this embodiment as ball-shaped to be received within and functionally mated with socket/cup-shaped nozzle end 1b. Mating permits a rotational and angular movement of the cup about the ball and the fit between the two is preferably frictionally tight. The cup and ball also each have opposing luminal channel orifices that line up when ball is fitted within cup and that permit flow through the overall implement when in use. Also shown is a flanged ring 2c on handle portion that facilitates sealing with a source or vacuum line (not shown). The ball-shaped male end need not be perfectly spherical or hemispherical as long as rotational ability and luminal space communication during vacuuming/suctioning/irrigation is sufficiently retained for the procedure at hand. The top of the ball, for example, may give the impression of having been planed to allow for a luminal bore or channel there through to interface with a corresponding luminal bore or channel in the complementary female socket. When fitted together the luminal channels abut to communicate with one another along the length of the implement as a whole.

The ball and socket design limits somewhat the maximum angle of bend that can be achieved, but this can'be overcome, e.g., by adding one or more additional ball and sockets in series, e.g., as shown in the joint depicted in FIG. 2.

The fit between the male and female ends should be frictionally tight but still permit operational rotation or angling upon application of desired force. The male portion can be retained within the female portion.

An internal flanged ring or series of retaining points or detents in or along the inner face of the mouth of the female socket (not shown in the figures) can optionally be used to retain the ball upon snap or press-fitting into the female flanged end, such that the ball can still rotate in the socket, but resist detaching from the socket. This ring or series of retaining points can be integral to the female piece and corresponding mold. The person of ordinary skill will appreciate that other retaining means can also be used.

The ends may be made to be conforming to one another, i.e. one or both ends can expand or compress relative to their complementary end upon press- or snap-fitting to allow the ends to engage one another with the desired functional fit.

### EXAMPLE 2

### A Dual Ball and Socket Joint Embodiment

FIG. 2 shows an implement embodiment featuring a dual ball and socket joint in which the second end of the nozzle portion 1b does not directly contact the second end of the handle portion 2b, but does so indirectly via adapter/connector 3 interfaces 3a and 3b, which in this particular configuration are essentially identical and inter-convertible with one another. Adapter/connector ends 3a and 3b could both equally well be ball-shaped were nozzle portion end 1b and handle portion end 2b both configured as socket-shaped. Alternatively, adapter/connector 3 could be configured as asymmetrical, with one end featuring a ball and the other end a socket, each designed to engage a reciprocally configured end of the respective nozzle and handle portions.

Lockwood Products, Inc. of Lake Oswego, Oreg., USA (see www.locline.com/couplings-adaptors.php) offers a variety of different adapter/connector types for other purposes on which the adapter connectors of the instant invention could be based or mimicked in whole or part.

### EXAMPLE 3

### A Rotary Joint Embodiment

FIGS. 3 and 4 illustrate two rotary joint embodiments in which ends 1b and 2b are not ball and socket configured and functionally marry at an angle (here ˜90°) relative to the longitudinal axes of the handle and nozzle portions when those portions are extended maximally away from each other. In this particular embodiment, the joint-mating portions of ends 1b and 2b, respectively 1bi and 2bi, are of complementary design and configuration such that when mated they afford a rotationally communicative drum joint having an internal luminal passageway extending along the entire implement as for the previously discussed embodiments. Such configuration could make use of a shunted or skewed internal luminal spacing at the point of intersection of opposing complementary pieces (e.g., relative to the central longitudinal axis of the handle at the point of intersection with the abutting reciprocal facing supplied by the nozzle, or vice-versa).

Regardless, the degree of transverseness of the rotary joint position relative to handle longitudinal axis can be anywhere from 0 to 90° or more.

The advantage of this particular type of joint is that it can offer greater angular reach of nozzle end 1a than can the ball and socket joints of Examples 1 and 2. If the transverse joint is configured long/wide enough and perpendicular enough relative to the handle and nozzle portions and their axes, a 360° rotation can theoretically be achieved, as the handle and nozzle portions could be configured to rotate in substantially parallel planes with respect to one another.

In an alternative rotary joint embodiment, the joint could also take on a ball and socket configuration (not shown), with a transverse axial angle relative to the ball and socket joints of Examples/FIGS. 1 and 2, with the internal passageway/luminal space functionally preserved as for the ball and socket embodiments previously discussed.

1. An adjustable suctioning implement for dental or medical applications, comprising:
a hollow handle portion having a source end for connecting to a vacuum line or pump and a second end, said source end having a diameter width of between about 0.40 and 0.50 inches;
a hollow nozzle portion having a contacting end for engaging a patient surface to be suctioned and a second end for functionally engaging, directly or indirectly, said second end of said handle; and
a hollow joint, said joint at least partially defined by said second end of said handle and said second end of said nozzle.

2. The implement of claim 1 comprising a single joint defined by a single ball and a single socket, wherein said ball and said socket are each integrally molded with one or the other of said second ends of said handle and nozzle such that a single, functional ball and socket joint is produced upon assembly of said handle and nozzle at their respective second ends.

3. The implement of claim 1 wherein said joint comprises a dual ball and socket joint.

4. The implement of claim 3 wherein said dual ball and socket joint comprises a single modular adapter cooperatively positioned between and abutting said second end of said nozzle and said second end of said handle.

5. The implement of claim 4 wherein said modular adapter comprises either two integrally molded balls or two integrally molded sockets facing away from each other.

6. The implement of claim 1 wherein said joint is a rotary joint.

7. The implement of claim 6 wherein said handle and said nozzle portions comprise two substantially parallel planes with respect to one another.

8. The implement of claim 1 further comprising an aperture in one or more of said handle portion, nozzle portion or joint that allows for operator-mediated pressure adjustment at the patient surface of engagement.

9. The implement of claim 1 comprising one or more materials selected from the group consisting of metal, molded plastic, rubber, glass and paper.

10. The implement of claim 1 comprising, at least in part, injection molded plastic.

11. The implement of claim 1 wherein at least one of said handle and said nozzle portions features a tapering from one end of said portion to the other end of said portion.

12. The implement of claim 1 having one or more dimensions selected from the range of dimensions consisting of:
nozzle length: 0.0-5.0 inches;
nozzle width: 0.1-0.5 inches;
handle length: 1.5-6.0 inches;
handle width: 0.1-1.0 inches; and
wall thickness: 0.01-0.10 inches.

13. The implement of claim 1 wherein said contacting end of said nozzle is beveled.

14. The implement of claim 1 wherein said contacting end of said nozzle is not perpendicular to the longitudinal plane of said nozzle.

15. The implement of claim 1 comprising both a ball and socket joint and a rotary joint.

16. A method of aspiration, comprising:
connecting a pump or aspirator to the source end of the handle portion of the implement of claim 1;
applying the contacting end of the nozzle portion of said implement to a patient surface to be suctioned; and
suctioning said patient surface.

17-20. (canceled)
